(19) United States
(12) Patent Application Publication
(10) Pub. No.: US 2008/0038684 A1
(43) Pub. Date: Feb. 14, 2008

(54) Systems and Processes for Computationally Setting Bite Alignment

(76) Inventors: Scott Keating, Louisville, CO (US); Eric Ponslet, Los Alamos, NM (US)

Correspondence Address: GLENN L. WEBB;GLENN L. WEBB P.C., P.O BOX 951, CONIFER, CO, 80433, US

(21) Appl. No.: 11/747,195

(22) Filed: May 10, 2007

Related U.S. Application Data
(63) Continuation of application No. 11/307,242, filed on Jan. 27, 2006, now abandoned.
(60) Provisional application No. 60/593,600, filed on Jan. 27, 2005.

(51) Int. Cl. A61C 11/00

(52) U.S. Cl. 433/24; 433/213

(57) ABSTRACT

A computational process for determining the appropriate bite alignment of an individual. The system and processes use digital models of the upper teeth, lower teeth and bite impression of an individual. Those models are fitted together in an appropriate bite alignment. The relative movement of the models are tracked mathematically. An optimization function is then used to determine the best fit between the models.

### RELATED APPLICATIONS

This invention is a continuation of Ser. No. 11/307,242, filed on Jan. 27, 2006 which claims benefit from provisional application 60/593,600 filed on Jan. 27, 2005.

### FIELD OF THE INVENTION

This invention relates to the field of setting the bite alignment of an individual automatically for dental and orthodontic purposes.

### BACKGROUND OF THE INVENTION

A natural bite is an important consideration in the health of most people. In dental terms, a bite is known as occlusion, and is an entire field of study regarding the spatial alignment of teeth in the mouth. A natural bite should ideally consist of perfect alignment in both vertical and horizontal directions. Should a tooth be out of alignment, or an entire jaw for that matter, unnatural spaces are created. This is known as malocclusion, and constitute a serious matter for a patient. The result of malocclusion is a wide range of problems from gum damage to headaches.

When the jaws close and teeth touch together, the jaws act as hinges. The teeth should come together evenly, at the same time, with evenly distributed force, without any tooth or teeth touching before another. When teeth don't touch evenly, this puts stress on the teeth, supporting bone, jaw joints and muscles. This may even cause temporomandibulor jaw disorder (“TMJ”).

Treatment of these problems is often undertaken through orthodontics. A critical function of orthodontics is the alignment of a patient's teeth to positions for the proper functionality as well as aesthetics of the patient's mouth. Typically this is accomplished through the use of orthodontic appliances such as braces. These appliances apply force to the patient's teeth until the proper alignment is reached.

The alignment process is also critical in the replacement or repair of existing teeth as well. It is important that the crown of the tooth being repaired or replaced be properly aligned with the companion teeth as well as the opposing teeth not only for aesthetic reasons but for proper functioning of the teeth as well.

Traditionally, determining the proper position of the alignment of the patient's teeth, often referred to as the bite alignment, is accomplished by the use of dental models. Generally, these models are created by obtaining impressions of the patients upper and lower dental arches. A bite impression is also obtained, usually by the use of a wax bite plate. Casts of these dental and bite impressions are then made and installed in a mechanical articulator. These mechanical articulators are then used to mimic the motion of the patient's jaws and teeth to establish the proper bite alignment of the patient's teeth.

There have been attempts to create a digital image version of the articulation process. These attempts typically utilize a digital image of the dental structure of the patient by digital x-rays, computed tomography, magnetic resonance imaging or other techniques. Then a computer simulation of the articulation of the patient's jaw structure is used to establish the proper bite alignment of the patient's teeth.

Even though the latter attempts create a computer simulation of the articulation of the patient, the proper bite alignment is still a mechanical or subjective approach requiring the intervention of a skilled technician.

### SUMMARY OF THE INVENTION

The present invention solves these and other problems by providing an automated system for establishing the proper bite alignment of an individual through the use of digital models of the individuals teeth and jaw. The system and processes of the present invention eliminate the need for manual intervention as presently is used for creating bite alignments of a patient. The need for bite alignments is critical for the design and installation of orthodontic ligatures, for dental implants, for reconstructive surgery and other needs.

A preferred embodiment of the present invention uses computational processes to create the proper bite alignment of the patient. These computation processes are based on a digital model of the patient's mouth. This digital model is rendered from computed tomography (“CT”), magnetic resonance imaging (“MRI”), digital x-rays, destructive scanning, or other techniques.

In a preferred embodiment, digital models are created from impressions or casts of the patient's lower dental arch, the patient's upper dental arch and the patient's bite impression. Volumetric digital data sets are created by the CT scanning or other technique and used to generate meshes that virtually represent the upper teeth, the lower teeth and the bite impression of the patient.

The present invention in a preferred embodiment then uses computational processes to align the upper and lower teeth together. This creates the appropriate bite alignment of the patient. The information derived from this process is used to for applying orthodontic ligatures, for reconstructive dentistry, for dental implants or other uses for treating or preventing malocclusions.

These and other features of the present invention will be evident from the ensuing detailed descriptions of preferred embodiments and from the drawings.

### BRIEF DESCRIPTION OF THE DRAWINGS

FIG. 1 is a digital model of an upper dental arch of a patient.

FIG. 2 is a digital model of a bite impression of a patient.

FIG. 3 is a digital model of the lower dental arch of a patient.

FIG. 4 illustrates the translations and Euler angles in relation to global coordinates of the digital models.

### DESCRIPTION OF PREFERRED EMBODIMENTS OF THE PRESENT INVENTION

The present invention provides systems and process for providing a fully automated method of bite alignment for dental and orthodontic purposes. Preferred embodiments of these systems and processes are discussed below. It is to be expressly understood that this descriptive embodiment is provided for explanatory purposes only and is not meant to limit the scope of the claimed invention. Other types and uses of the systems and processes are also considered to be within the scope of the present invention.

A preferred embodiment of the present invention provides a computational process for performing bite alignment on digital models of a patient's dental arches. This computational process eliminates the need for manual intervention that is normally required for such bite alignments. The need for bite alignments is critical for the design and installation of orthodontic ligatures, for dental implants, for reconstructive surgery and other needs. It is to be expressly understood that while the present embodiment is described for use in creating bite alignments of patient's dentition, this process may also be used in other processes as well.

The process of the preferred embodiment utilizes a digital model of the patient's dentition, such as from computed tomography (“CT”), magnetic resonance imaging (“MRI”), digital x-rays, destructive scanning, or other techniques. In a preferred embodiment, digital models are created from impressions or casts of the patient's lower dental arch, the patient's upper dental arch and the patient's bite impression. The techniques for creating these impressions and casts are well known.

As described above, the bite alignment of the patient's dentition currently requires either manual articulation of physical models of the patient's dentition, or else computer simulation of the articulation of digital models that still require manual intervention to arrive at the appropriate bite alignment.

The present invention uses computational processes to eliminate the need for the manual or semi-manual bite alignment. Each of the digital models are registered with one another to create the proper bite alignment between the models and thus the patient's teeth. Registration refers to the fitting together of two or more objects that were scanned apart from on another. If the registered objects are fully encapsulated with one another, then those objects are matched. If the objects are only partially encapsulated with one another, then those objects are partially matched.

In the preferred embodiment, the volumetric digital data sets of the teeth and bite of the patient are created by CT scanning. The common output derived from volumetric computed tomography data are tessellated structured polygonal meshes and three dimensional point clouds. This embodiment derives the digital output of the patient's dentition by scanning spatially independent plastic impressions representing the upper and lower teeth and the bite that is made by those teeth when the patient's jaws are closed. Each of the impressions are independently scanned by CT or other processes. Meshes are then generated from this digital output to virtually represent the upper teeth, the lower teeth and the bite impression of the patient.

At this point, the mesh digital models are considered to be matched or partially matched and unregistered. The preferred embodiment then uses computational processes to register the upper and lower teeth, that is, to fit or align the upper and lower teeth together naturally and uniquely. This creates the appropriate bite alignment of the patient. The digital data set that is created by scanning the impressions of the upper teeth, lower teeth and bite of the patient is used to perform this registration. This registration will create a close estimation of the patient's mouth in a naturally closed position.

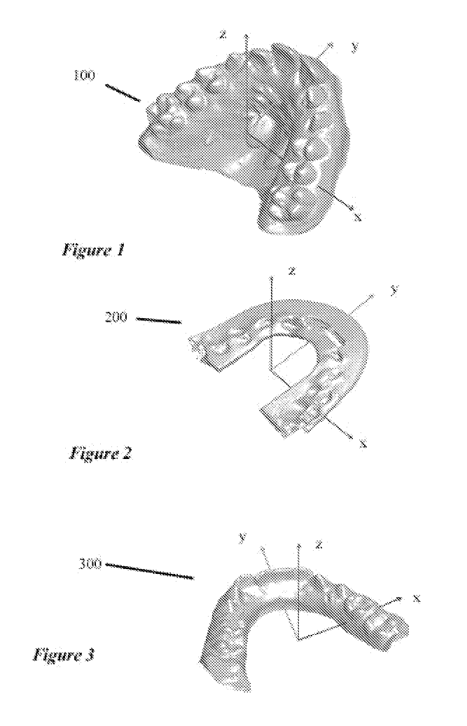

Examples of the three models created from the impressions or casts are shown in FIGS. 1-3. Model 100 in FIG. 1 represents the upper teeth, model 200 in FIG. 2 represents the bite impression and model 300 in FIG. 3 illustrates the lower teeth. In this preferred embodiment, each of the models are given a local coordinate system. It is to be expressly understood that the present invention does not depend on these local coordinate systems. They are provided in this embodiment as a tool that is often used by orthodontists. Each of these local coordinate systems are related to an observer based global coordinate system.

One of the models is then selected as a fixed reference point. For example, the lower model 300 is selected as the fixed reference point. Then the bite impression model 200 is moved into alignment with the lower model 300 so that it fits onto the lower model 300. Then the upper model 100 is moved until it fits with the already placed bite impression model 200.

The system and process of the preferred embodiment being described tracks the movement of each model mathematically by the translation and rotation of each model. In this embodiment, the mathematically tracking is done by linear (Euclidian) translations and Euler angle rotations. It is to be expressly understood that other types of mathematical tracking may be used as well.

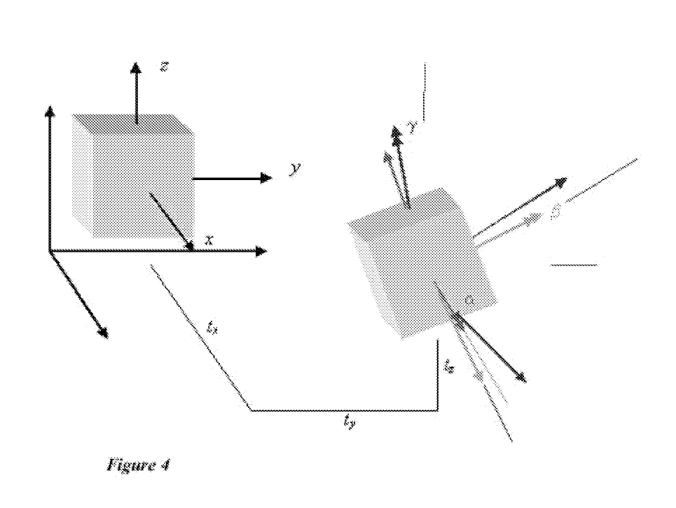

A combination of linear translations and standard Euler rotations are shown in FIG. 4. Each of the models are represented by vertex triples (X,Y,Z axes) in the figure. Each group of vertex triples has a “best fit” between the bite impression and the lower model and between the upper model and the bite impression over some portion of their surface. In the first portion of the alignment or registration process, the lower teeth model is considered as a stationary model and the bite impression model is considered the moving model. In the second portion of the process, the bite impression model is considered the stationary model and the upper teeth model is considered the moving model.

In the preferred embodiment of the present invention, the process utilizes a penalty function that describes the quality of alignment between the models. This quality of alignment may best be described as a function that favors good alignment of some of the vertex (model) data while reducing the effects of vertex data that does not contribute to a best fit.

The penalty function is first derived from:

$$\prod = {\sum }_{i = 1}^{m} {\sum }_{j = 1}^{n} \frac{1}{{d}_{ij}^{2} + {ɛ}^{2}}$$

where:
dᵢⱼ²=(xᵢ−xⱼ)²+(yᵢ−yⱼ)²+(zᵢ−zⱼ)²
is the standard Euclidian distance between pairs of triples. The rigid body rotation and translation of data from one global position to another is encapsulated as:

$$\{ \begin{matrix}{x}_{i} \\ {y}_{i} \\ {z}_{i} \\ 1\end{matrix} \} = [ \begin{matrix}cos ( β ) cos ( γ ) & sin ( α ) sin ( β ) cos ( γ ) - cos ( α ) sin ( γ ) & cos ( α ) sin ( β ) cos ( γ ) + sin ( α ) sin ( γ ) & {t}_{x} \\ cos ( β ) sin ( γ ) & sin ( α ) sin ( β ) sin ( γ ) + cos ( α ) cos ( γ ) & cos ( α ) sin ( β ) sin ( γ ) - sin ( α ) cos ( γ ) & {t}_{y} \\ - sin ( β ) & sin ( α ) cos ( β ) & cos ( α ) cos ( β ) & {t}_{z} \\ 0 & 0 & 0 & 1\end{matrix} ] \{ \begin{matrix}{x}_{o} \\ {y}_{o} \\ {z}_{o} \\ 1\end{matrix} \}$$

The translation and Euler angle rotations then must be solved in order to provide an appropriate bite alignment. This can be represented as:

$$m = \{ \begin{matrix}{t}_{x} \\ {t}_{y} \\ {t}_{z} \\ α \\ β \\ γ\end{matrix} \}$$

There are a number of techniques that can be used to solve for the translation and Euler angle rotations. One example of an optimization technique is to determine the incremental change in the translation and Euler angle parameters from Taylor series expansion such as:

$$\frac{\partial Π}{\partial {m}_{j}} δ {m}_{i} δ {m}_{j} = 0 or \frac{\partial Π}{\partial {m}_{j}} δ {m}_{j} + J δ {m}_{i} δ {m}_{j} = 0$$

$$J δ {m}_{i} δ {m}_{j} = \frac{\partial Π}{\partial {m}_{j}} δ {m}_{j} or δ {m}_{i} δ {m}_{j} = - {J}^{- 1} \frac{\partial Π}{\partial {m}_{j}} δ {m}_{j}$$

Removing δmⱼ from each side yields:

$$δ {m}_{i} = - {J}^{- 1} \frac{\partial Π}{\partial {m}_{j}}$$

where J (Jacobian) is the 6×6 matrix of second derivatives.
Then iteratively,
mᵢ^{k+1}=mᵢ^{k}+δmᵢ

This routine is iterated until Π or alternatively, the norm of the incremental change changes less than a specified value.

It is to be expressly understood that other optimization techniques may be used as well as other mathematical models of the bite alignment process. The above descriptive embodiments are provided for explanatory purposes only and are not meant to unduly limit the present invention.

This information as to the appropriate bite alignment may then be used for apply orthodontic ligatures, for reconstructive dentistry, for dental implants or other uses for treating or preventing malocclusions.

1. A process for determining the appropriate bite alignment for an individual, said process comprising the steps of:
creating at least two digital models representing the dentition of the individual;
moving one of said digital models relative to another of said digital models;
mathematically tracking the relative movement of said digital models; and
optimizing the best fit between said digital models.

2. The process of claim 1 wherein step of creating at least two digital models representing the dentition of the individual includes:
creating digital models from impressions of the patient's lower dental arch, the patient's upper dental arch and the patient's bite impression.

3. The process of claim 1 wherein said step of creating at least two digital models includes:
creating volumetric digital data sets of the teeth and bite of the patient from computerized tomography data; and
generating digital meshes from said volumetric digital data sets to virtually represent the upper teeth, the lower teeth and the bite impression of the patient.

4. The process of claim 1 wherein said process further comprises:
registering said at least two digital models with one another.

5. The process of claim 1 wherein said process further comprises:
registering said at least two digital models with one another by fitting each of said at least two digital models with on another.

6. The process of claim 1 wherein said process further includes the step of:
creating the appropriate bite alignment of upper and lower teeth of the patient by registering said digital models to one another.

7. The process of claim 1 wherein said process further includes the step of:
registering said at least two digital models with one another by using computational processes to fit each of said at least two digital models with one another.

8. The process of claim 1 wherein said process further includes:
selecting one of said digital models as a fixed reference model;
selecting another of said digital models as a bite impression model; and
moving said bite impression model into alignment with said fixed reference model to register said fixed reference model and said bite impression model with one another.

9. The process of claim 1 wherein said process further includes:
selecting one of said digital models as a fixed reference model;
selecting another of said digital models as a bite impression model;
moving said bite impression model into alignment with said fixed reference model to register said fixed reference model and said bite impression model with one another; and
moving any remaining of said digital models into alignment with said bite impression model to register the remaining of said models with said bite impression model.

10. The process of claim 1 wherein said step of mathematically tracking the relative movement of said digital models includes:
tracking the movement of said digital models relative to one another by Euclidian translations.

11. The process of claim 1 wherein said step of mathematically tracking the relative movement of said digital models includes:
tracking the movement of said digital models relative to one another by Euler angle rotations.

12. The process of claim 1 wherein said step of optimizing the best fit between said digital models includes:
creating a penalty function that increases the effect of the data that increase the alignment between the models and reduces the effects of the data that does not contribute to the alignment between the models.
